(19) United States
(12) Patent Application Publication
(10) Pub. No.: US 2011/0125646 A1
(43) Pub. Date: May 26, 2011

(54) Methods and systems for managing personal health records by individuals

(75) Inventor: Siu-ming Yung, Hong Kong (HK)

(73) Assignee: Cosmo Solution industrial Center, Shatin (HK)

(21) Appl. No.: 12/622,433

(22) Filed: Nov. 20, 2009

(51) Int. Cl. G06Q 50/00; G06Q 10/00; G06F 17/30; G06F 15/16; G06F 21/20; G06F 12/14; H04L 9/28

(52) U.S. Cl. 705/50; 705/3; 707/827; 707/741; 709/201; 726/4; 713/189; 707/E17.032; 707/E17.045

(57) ABSTRACT

A Data processing methods and systems adapted to manage personal health records by individuals. Wherein the patient undergoes encounters with a plurality of health care providers who generate personal health data of the patient. A storage device configured to perform tasks of a personal health record server (“PHRS”) comprising procedures to encrypt and store personal record data, to authenticate the access right of the requester, to create response to requester with associated personal health related information, to transfer personal health related information from/to information generating or storage devices; and to communicate with user via network. Personal health record server can be installed in a portable USB device and can start serving immediately after being inserted into a computer's USB port, personal health record stored can be accessed either by the said computer locally or by other computers requesting via internet through authenticated requests.

### FIELD OF THE INVENTION

The invention relates generally to computer methods and systems and more particularly, to computer methods and systems for managing personal health records by individuals. In one embodiment, a system/method encrypts and stores all significant personal health records in a personal server configured for responding to access request from standalone computer with no network connection or internet, personal health record stored can be accessed through the access request to the personal server only. Personal server can be installed in a portable USB device and can start serving immediately after being inserted into a computer's USB port.

### BACKGROUND OF THE INVENTION

Electronic health records are established by health care providers such as hospitals, imaging centers, diagnostic laboratories and physicians. The electronic health records are commonly stored in databases managed by the health care providers. Normally, patient records are stored in the health providers' database that serves administration, medical research; data mining for pandemic risk assessment and infection prediction etc. are health care provider eccentric. In other words, individual patient's health record is a set of records in the health care providers' database; we have to trust the health care providers' security measures to protect the privacy of individual health record.

The gathering of patient eccentric personal health records from a plurality of health care providers is becoming more demanding basically for two reasons: firstly it is difficult for practitioners to make judgments while diagnosing patients unless they have a full picture of the patient's health history, a full sets of personal health records will serve; patient are safe to travel around if personal health record could always be available, and secondly patients should have their rights to possess and to control their own health records against being abused.

Attention has been drawn to the generation and standardization of personal medical records targeted to build a centralized medical record database that could serve all patients. Another attention has been drawn to the security and privacy of the personal medical record stored in a centralized database.

If health care providers have to serve the centralized personal health records database, they shall not copy directly from their own database but to have some programs to filter and generate extractions of patient health records from their database.

Patient data can be centralized only if all providers are willing to conform to a standardized format, the reality is: Hospitals are using Hospital information system (“HIS”), Laboratory information system (“LIS”), and radiology information system (“RIS”) to handle data, while private practice or small scale operation physicians, Laboratories and Radiologists are using their own proprietary information systems.

More specifically, some physicians are still using hand writing prescription while others are using computer; some radiologists are using traditional silver bromide film for X-ray while other are using CR; some are using CT/MRI imaging systems while others are using barium milk and X-Ray; some diagnostic laboratory reports are generated by LIS while others are generated by word processors; some ECG reports are stored as a XEROX copy while the others are scanner images. A patient health record will lose its meaning unless all chronological information is gathered together for inquiry. Attempts to build Centralized patient database may not be practical if generations of physicians and diagnostic methodologies co-exist.

The purpose of the centralized health record database is to help patients to gather their personal information for health care purpose. Data mining on centralized personal health database cannot produce finding better that those on Hospital database.

However, centralized health record database is not the only solution for information dissemination. If patient is provided with a system and method to manage personal health record (hereafter “PHR”), the advantages being firstly it is at his discretion to allow or not to allow access to his own PHR; and secondly he can make use of his own PHR whenever and wherever it is required.

The actual use of PHR further indicates that letting the patient to manage his own PHR is feasible because firstly for the purpose of personal health care, text, documents and images intelligible to health care practitioner is already good enough, and secondly it is much practical for health care practitioner to furnish health data in their original formats being proofread and as stored in the practitioner's information system.

An Object of the invention is therefore to provide a system and method to allow patient to manage his own PHR.

### SUMMARY OF THE INVENTION

The present invention is system and method for managing personal health records (“PHR”). In contrast to the centralized patient database, this invention provides a much simple way by letting individual patients to manage their own health records.

A personal health record Server (hereafter “PHRS”) is built on an electronic storage device; wherein the said storage device stores encrypted PHR, it also stores software engines that provide the functionality required for PHRS.

Health records stored in said storage device may be hand writing images, Word processor files, X-ray images, Digital Imaging and Communications in Medicine (hereafter “DICOM”) series, Health Level Seven (hereafter “HL7”) datasets, voice and video in form of files, not limited to series of files or records.

PHR are encrypted so that direct access to the data files consisting of PHR in the storage device is not intelligible to human.

Encryption of PHR is conducted by using two keys, one is an individual key unique to patient, and the other is a hardware key unique to the storage device.

Software programs are stored in the said storage device so that upon activation, said storage device can serve as a server providing tasks for health records management service.

The said tasks for health records management service provided by the said server comprising user authentication and access control, user interfaces for health record querying, viewing, inserting and updating, health records transfer from/to backup or image generation systems, not limited to health record and client systems/users management.

The said client systems/users may be anyone possessing the access right as authorized by the patient.

The said storage devices may be a removable hard disk, USB drive, not limited to any read-writable electronic storage device that can be connected to and read-writable by a computer.

The said software engines stored in the said storage device may include file server engine, record server engine, communication engine, application server engine and web server engine.

The said file server engine provides file accessing functions that maintain files identified by the file names.

The said record server engine provides record accessing functions that maintain data organized as tables.

The said communication engine provides communication functions for internet data exchange comprising methods to capture real time data generated by personal health monitoring devices; receive/send files and datasets from/to inquirer, receive/send DICOM series from/to storages or image generating systems.

The said application server engine provides functions to execute programs written for providing the logic of procedure conducting the flow of tasks.

The said programs are computer readable instructions stored thereon for execution by a processor to perform task.

The said web server engine provides web functions to serve requests posted from requesters.

Basing on the functions provided by the said software engines, the said PHRS is configured to provide methods comprising access authentication, PHR insertion, deletion and query, web request services with responding pages formatted with PHR information embedded, PHR files or images transfer, PHR backup and update.

According to one aspect, the invention provides a system/method for the patient to have control over his own PHR.

According to another aspect, the invention provides a system/method to have the medical records retrieved whenever and wherever it is required.

According to another aspect, the invention provides a system/method to control the accessing of PHR; PHR stored could be accessed only through requests served by the PHRS only.

According to further aspect, the invention provides methods for health care practitioner to view online data captured by personal health monitoring devices, to view text, files, and diagnostic images through web browser that is commonly available in computers.

According to further aspect, the invention provides a method for health care practitioner to upload text, files, and images through web browser.

According to further aspect, the invention provides a system/method for collecting delayed health records by a backup system that communicates with the health records generators, and to update the PHR stored in PHRS, not limited to rebuild the PHRS in case of damage.

Additional features and advantages of this invention to those skilled in the art will become apparent upon consideration of the following detailed description of the illustrated embodiment exemplifying the best mode of carrying out the invention as presently perceived.

### BRIEF DESCRIPTION OF THE DRAWINGS

FIG. 1 shows a diagrammatic representation of a PHRS in a health care system according to an embodiment of the present invention.

FIG. 2 shows a block diagram of functional engines stored in the PHRS as files in a storage device as seen from a computer after connection according to an embodiment of the present invention.

FIG. 3 shows a block diagram of the tasks performed by the functional engines stored in the PHRS after being connected to a computer according to an embodiment of the present invention.

FIG. 4 shows an example window in which USB PHRS operates in the health care practitioner's clinic; access to the PHR from the USB PHRS is authenticated by reading smartcard provided by the patient.

FIG. 5 shows an example window in which health care practitioner access the PHR from the USB PHRS, chronological health information of patient are shown on the web browser.

FIG. 6 shows an example window in which health care practitioner select via the web browser specific diagnostic images in the patient's chronological health information table, diagnostic images are shown on the web browser.

FIG. 7 shows an example window in which health care practitioner select specific laboratory diagnostic reports in the patient's chronological health information table.

FIG. 8 shows an example window in which the health care practitioner is provided with functions to upload patient's health records.

FIG. 9 shows an example window in which a backup system is in operation.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail.

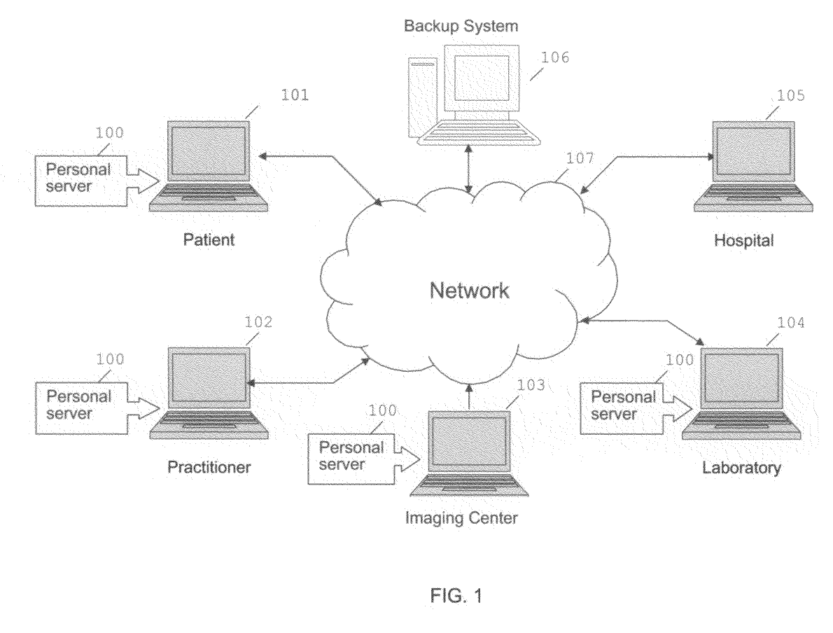

FIG. 1 shows one embodiment of the present invention. The PHRS 100 operates on an USB drive as a storage device. As shown, PHRS 100 may work together with patient's computer 101; PHRS may also work with practitioner's computer 103; imaging center's computer 104 and Laboratory's computer 105. A backup system 106 keeps the backup image of the said set of PHR.

The network 107 may be of any type of communication method that allows computing devices to transfer data; by communicating through the network 107, authorized clients systems/users may perform a plurality of tasks comprising of: PHR querying, viewing, inserting and updating, PHR transfer from/to backup system 106, from image generation system 104 or from reporting system 105, not limited to health record and client system/user management.

The present invention provides a method/system to allow the backup system 106 to receive delayed PHR comprising images and diagnostic reports generated by imaging center's computer 104, laboratory reports generated by of laboratory's computer 105, and to update the PHR later to patient's PHRS.

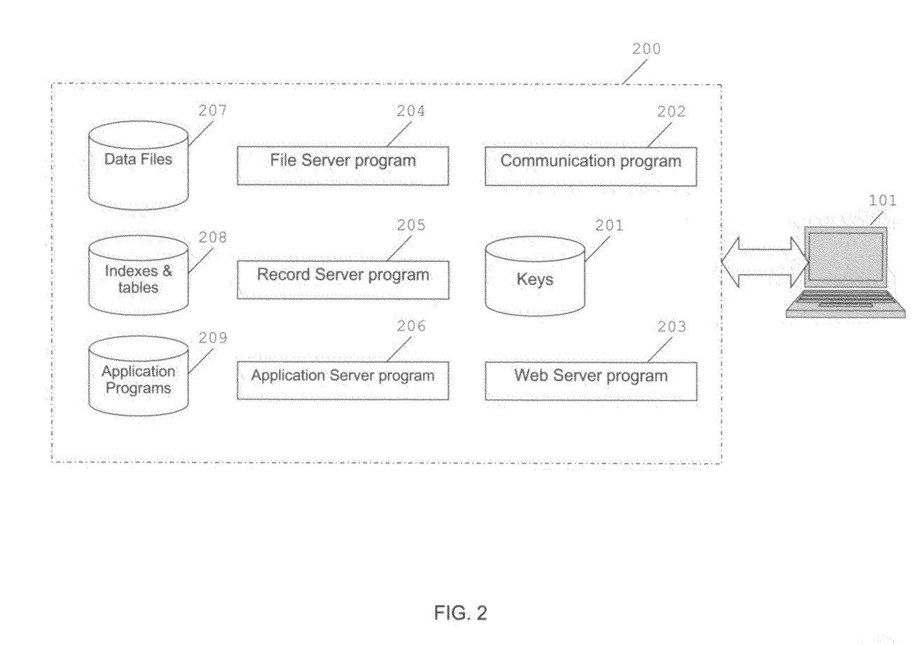

FIG. 2 shows example of embodiment of the present invention. In the embodiment, the PHRS 108 is connected to a patient's computing device 101 by inserting the USB disk PHRS 108 into the USB ports of 101. By connecting, computing device 101 has gained access to USB disk storage 200 comprising of the programs 202, 203, 204, 205, 206 and data 201, 207, 208, 209.

Said program 202, 203, 204, 205 and 206 are programs intended to be executed on the said patient's computer device 101 that provides the functions to perform tasks of the PHRS 108.

Said data 201 is set of keys, one of the said key is the unique patient key assigned to individual patient, another one of the said key is a unique device key assigned to the individual storage device. Multiple keys could be assigned for level of access control. Preferably, data 201 should be set read-only and be stored in a separate location in the storage device.

Said data 208 are tables and indexes generated from the PHR comprising of: indexes to files; full text search index for key words in the files of prescription, therapy or laboratory report, it may also be indexes on Optical Character Recognition result of the handwriting images; table of treatment history, not limited to table of physiological measurements.

Said data 209 are application programs to be executed by the application server Engine 206. Said application programs may be written in another language and are not directly executable by the said patients' computing device 101.

Said data 207, 208 and 209 are encrypted by using the said patient key and device key, said encryption may be any encryption method, direct access to or making copies of the data stored in disk storage 200 is not intelligible to human or computing device; privacy of patient are protected.

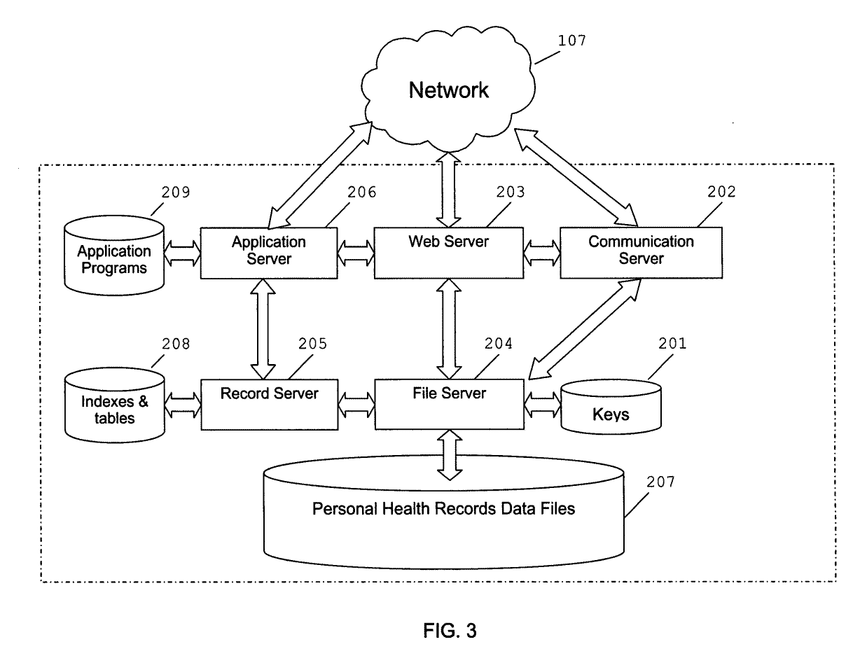

FIG. 3 shows example of embodiment of the present invention. In the embodiment, USB PHRS 108 is inserted into the patient's computing device 101 and the programs 202, 203, 204, 205 and 206 are activated. Patient's computer can provide PHR management tasks.

Program 202 is a communication server engine comprising methods to transfer data and files from/to client systems/users through network 107 via a plurality of protocols, said client system/users may includes patient's computer 101, practitioner's computer 102, imaging center's computer 103, laboratory's computer 104, hospital computer 105, not limited to backup system 106.

Said communication server engine 202 also comprises methods to capture real time data generated by personal health monitoring devices, said personal health monitoring device may be devices with data interface that capture computer readable measurements on personal physiological condition.

The said personal physiological conditions comprising of heart rate, respiratory rate, blood pressure, oxygen saturation, body temperature, electro cardiology, not limited to blood glucose.

Program 203 is a web server engine comprising methods to receive requests from the network 107, and to respond to the client systems/users with information; request and response may be in a format generally known as hypertext transfer protocol (“http”).

Said request to the web server 203 may be request comprising: authentication, treatment history retrieval, diagnostic report retrieval, diagnostic image retrieval, prescription updating, diagnostic report updating, diagnostic images updating, key word query, not limited to PHR backup and restore.

Said response to client systems/users may be information comprising of webpage with text and graphic, webpage with text dataset result from a query, webpage with results from a query comprising multi-media files; said multi-media files may includes diagnoses, treatment, medication, laboratory report, X-Ray image, images from DICOM series, voice, video, graphic or information of any type that is specialized in specific field of application. For example diagnostic images in the medical imaging field are series of files in DICOM format which can be displayed and animated in a webpage.

Program 204 is a file server engine comprising methods to identify, store and retrieve files by file name, directory name, not limited to owner name; to compress and decompress files; to encrypt and to decrypt files.

Said directory are a collection of files grouped under the same directory name, said owner are a collection of files grouped under the same owner name; owners are assigned different levels of files accessing right comprising of read, write, modify, create, not limited to delete operation.

Said compress methods shrinks a file to a fraction of the original size by labeling and mapping redundant contents in a file; said decompress methods restore the compressed file to its original content.

Said encryption methods replace file content by an encrypted content generated by algorithms that may be a function of the original content and encryption keys. Said decryption methods restore file original content from the encrypted content by algorithms that may be a function of the encrypted content and encryption keys.

Program 205 is the record server engine comprising methods to maintain data as record, table of records and database of tables; to maintain indexes on key items/combination of key items in records so that a record in a table can be retrieved quickly by referring to the key item's value; to maintain indexes on texts in files so that file containing the text could be searched by referring to a text value.

Said methods to maintain data may be methods to insert, delete, amend, copy, not limited to retrieve records in tables; said method to maintain indexes may be methods to insert, delete, amend, copy, not limited to retrieve key values in indexes.

Program 206 is the application server engine comprising methods to execute application programs written for providing the logic of procedure conducting the flow of tasks performed by the PHRS, said application programs may provide logic of procedure for client systems/users authentication, logic of procedure for dataset query, logic of procedure for webpage formatting with dataset obtained from query, logic of procedure for files transfer from/to clients systems/users, not limited to logic of procedure for backup/restore PHR to/from backup system.

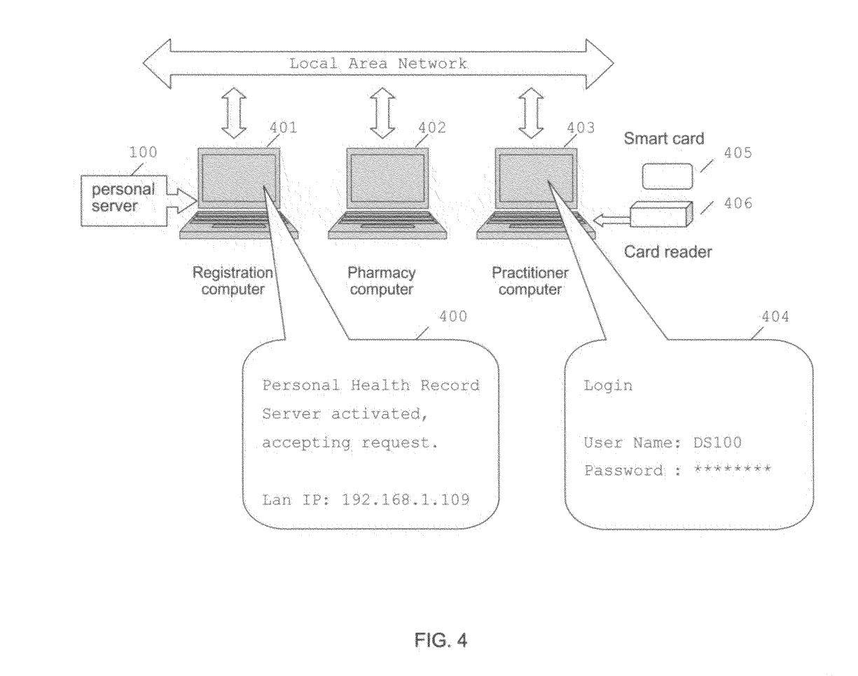

FIG. 4 shows example of embodiment of the present invention. In the embodiment, a health care provider are having registration computer 401, practitioner computer 402, and pharmacy computer 403 connected via a local area network, patient registers at the registration office of the health care provider by presenting his USB PHRS 100. By inserting the USB PHRS 100 into the USB socket of the registration computer 401, PHRS 100 is activated 400 and starts serving; the practitioner can start inquiring the patient's PHR via the web browser of the practitioner computer 403.

For security reason, the registration computer may scan the PHRS for computer virus before activating the PHRS 100, practically, only programs engines 202, 203, 204, 205 and 206 may be liable for computer virus infection and can be set read only to prevent from being infected.

Practitioner should login to the PHRS by entering proper user name/password as shown in 404; different user name/password may be assigned to differentiate access levels to PHR. Alternatively, user name/password may be recorded in smartcard, practitioner is provided with the appropriate smartcard 405 so that the login process could be simplified by presenting the smartcard to the card reader 406.

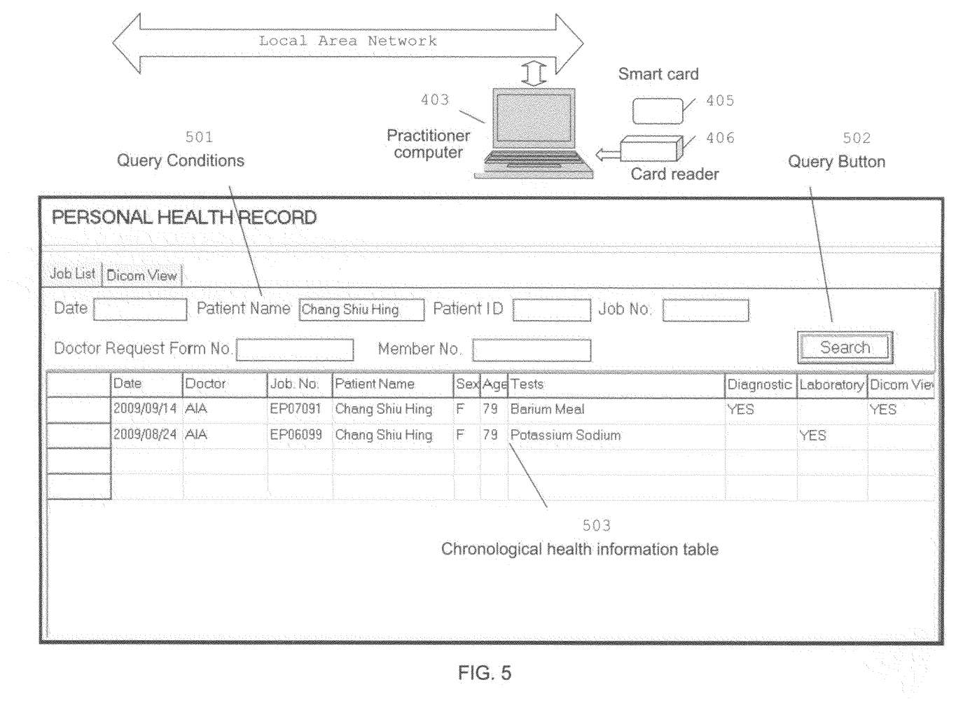

FIG. 5 shows example of embodiment of the present invention. In the embodiment, health care practitioner enter via the web browser of the practitioner computer 403 specific query condition at the locations 501; after clicking on the search button 502 by a pointing device, the patient's chronological health information table 503 fulfilling the query condition in the appearance of a web page is shown.

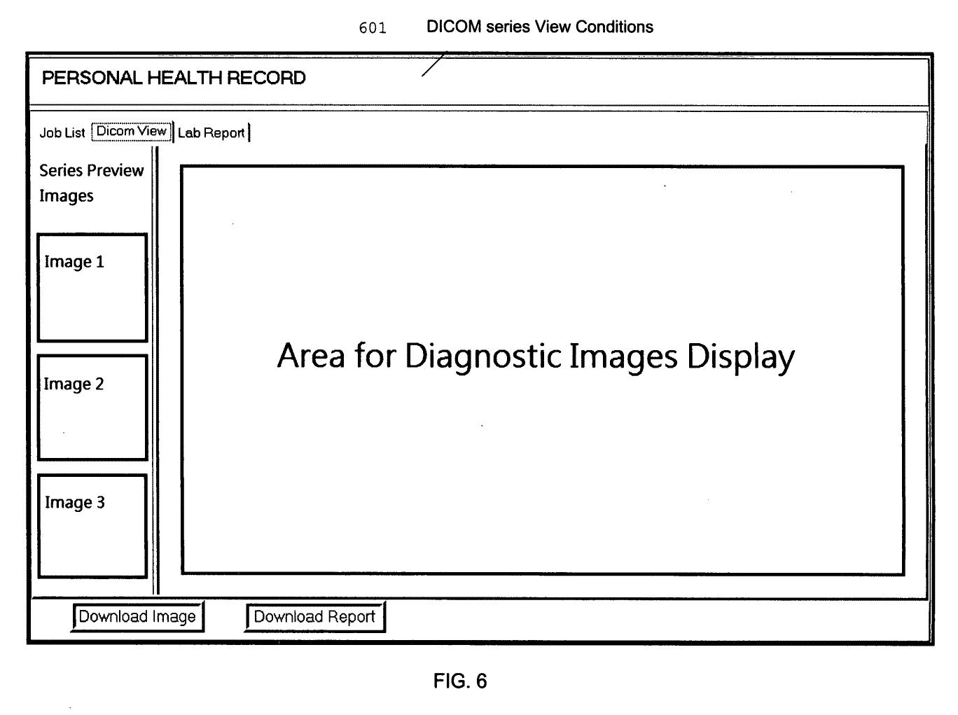

FIG. 6 shows example of embodiment of the present invention. In the embodiment, health care practitioner select via the web browser of the practitioner computer 403 specific diagnostic images in the patient's chronological health information table 503, corresponding image viewer in the said web browser will display the images 601 in the appearance of a web page as shown in this example.

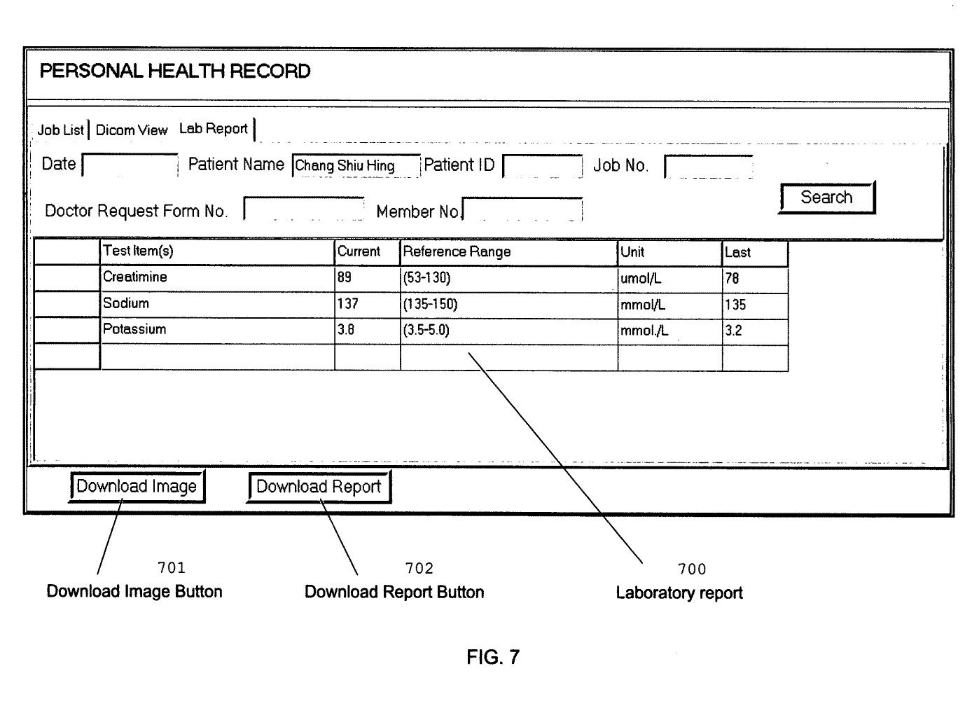

FIG. 7 shows example of embodiment of the present invention. In the embodiment, health care practitioner select via the web browser of the practitioner computer 403 specific laboratory diagnostic reports in the patient's chronological health information table 503, corresponding file viewer in the said web browser will display the laboratory reports 700 in the appearance of a web page as shown in this example.

The health care practitioner may be provided with functions to retrieve data, view images, download reports and images to his own information system; by the provision of the said functions, images and reports displayed on the web browser could be copied or downloaded by clicking download image button 701 or the download report button 702 to download the specific items displayed on the web page.

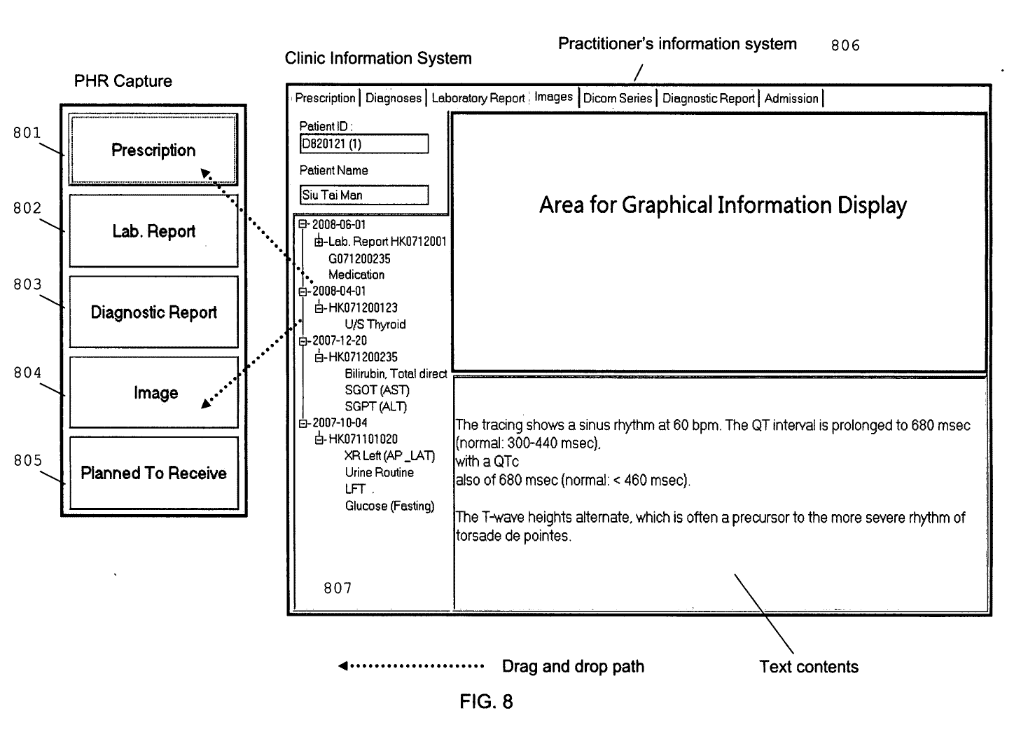

FIG. 8 shows example of embodiment of the present invention. In the embodiment, the health care practitioner are provided with functions to upload patient's health records comprising: his prescription, diagnosis, laboratory reports from laboratory, diagnostic reports from imaging center to the said PHRS, in case the data is in a form of file, he may upload by dragging and dropping related files 807 from his own information system 806 to the appropriate areas for prescription 801, diagnostic report 802, laboratory report 803, non-DICOM conformance images 804 and planned to receive items 805 on the web pages, in case the data is text 808 typed in his own information system, he may upload by copying and pasting the contents to said areas 801 on the web pages.

Said dragging and dropping may be the operation used in a computer with graphic user interface (“GUI”), allowing user to graphically move objects from a source to a destination by a pointing device, it may also be object moving command typed into a computer without GUI.

Said Copying and pasting may be the operation used in a computer with GUI, allowing user to graphically copying objects from a source to a destination by a pointing device, it may also be object copying command typed into a computer without GUI.

Upon receiving data from the health care practitioner, program in the application server engine will be executed; it begins organizing the data uploaded into records and indexes so that future retrieval could refer to the key items in data. For example, key words for Laboratory test items and unit of measurements in laboratory reports are standardized; they may be extracted, tabulated and stored for reference.

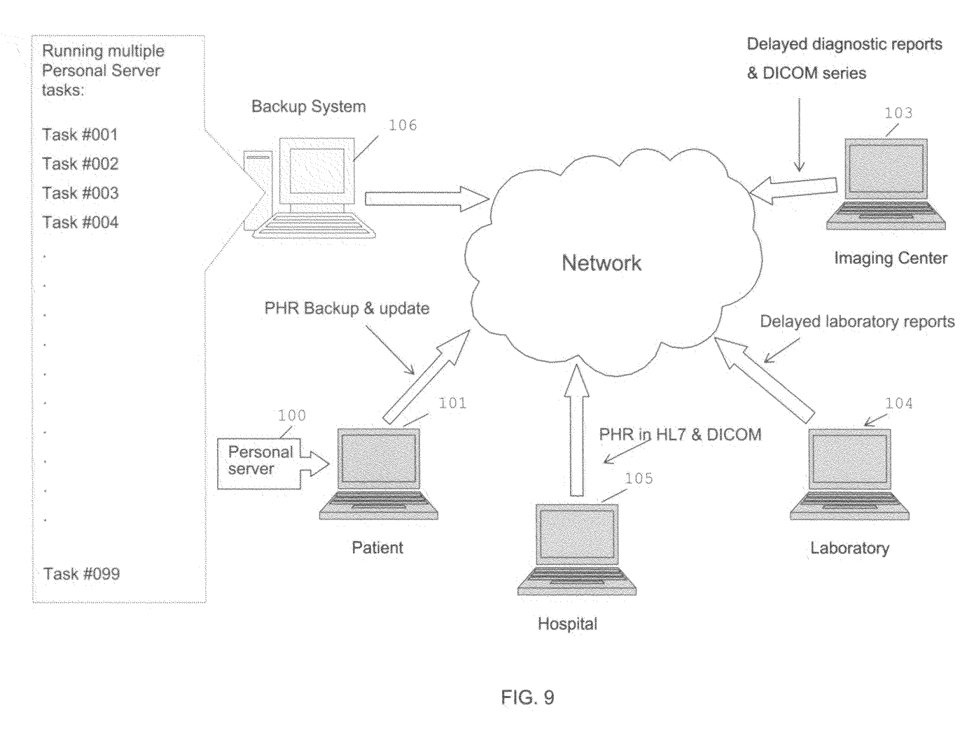

FIG. 9 shows example of embodiment of the present invention. In the embodiment, another requester of PHR is the radiologists in the diagnostic imaging center; before reporting on the images, radiologist may refer to the previous images or diagnostic reports by methods as described in FIG. 7 for a better understanding of the health situation of the patient; the data that diagnostic imaging center produced are basically, diagnostic images and diagnostic reports.

Said diagnostic images are produced by a plurality of diagnostic equipment modalities. For modern diagnostic center, images produced are computed radiology (“CR”) files or series of files in DICOM formats. But for older type of diagnostic center, some of the images are still captured by silver bromide negatives, if they are not digitized by high resolution CR equipment, the diagnostic information stored in said image may be distorted; non DICOM conformance images may be kept for reference only and can be uploaded to the PHRS by methods as described in FIG. 8.

Said diagnostic reports are generated by radiologists after referring to diagnostic images; they can be available only after a deferred period. Rather than gathering them into PHRS immediately while the patient is in the diagnostic imaging center, a system/method to receive delayed PHR is introduced.

FIG. 9 also shows example of embodiment of the present invention, a backup system 106 is configured to receive delayed PHR from a plurality of sources and also the CR files or series of files in DICOM formats from the Diagnostic Center's imaging device. In order to perform data transfer, DICOM receiving device has to be registered in the DICOM sender's registry, since registering all PHRS in diagnostic center's registry is not practical, the backup system 106 storing patient's backup PHR is configured to receive patient's DICOM series.

Said backup system 106 is configured to perform the same type of tasks as the PHRS, but having the capacity to perform a plurality of PHRS tasks concurrently. PHR stored is patient eccentric with encryption.

A hospital serves many patients together and may not be possible to handle individual patient's requirement of gathering the patient's own health record; a proper channel has to be set up for individual patient to gather his own health records from hospital's patient database, said database can be accessed in a more standardized way comparing to private sector, for example using HL7 format together with the DICOM format described before. In this case, backup system 106 again will serve the acquiring of data from hospital; procedure to capture PHR using HL7 format can be stored in the said backup system 106.

What is claimed is:

1. A data processing system for storing, authenticating and accessing personal health records, wherein the patient undergoes encounters with a plurality of health care providers, wherein the health care providers generate personal health related information of the patient; the data processing system comprising: a storage device configured to perform tasks of a personal health record server (“PHRS”) comprising: a file server engine comprising file accessing functions that maintain personal health related information as electronic data files identified by the file names; a record server engine comprising record indexing and accessing functions that maintain indexes to personal health related information tables and files; a web server engine comprising functions to receive request regarding the patient's health related information from network; an application server engine operably associated with file server engine, record server engine and web server engine comprising functions to execute programs that provide procedures to authenticate the access right of the requester, procedure to create response to requester with associated personal health related information, and procedures to transfer personal health related information from/to information generating or storage devices; and a communication engine comprising functions for personal health related information data exchange via network.

2. The system of claim 1, wherein said personal health related information is gathered as electronic data that can be stored in storage devices are handled as entries in the personal health records (“PHR”) for individual patient only.

3. The system of claim 1, wherein said health related information is transmitted in a form of data file with a plurality of data formats.

4. The system of claim 3, wherein said data formats include text, image of hand writing, graphic, DICOM series, HL7 datasets, photograph, not limited to voice and video.

5. The system of claim 1, wherein said file server engine is configured to perform file copy, amend, delete, insert, compress, decompress, not limited to encrypt and decrypt functions.

6. The system of claim 1, wherein said record server engine is configured to perform record insert, delete, amend and query functions and further to perform indexes on key items function.

7. The system of claim 1, wherein said communication server engine is configured to perform data transmitting and receiving functions in a plurality of protocols.

8. The system of claim 7, wherein said protocols includes data communication standards comprising DICOM series transfer, web pages hypertext transfer, files transfer, not limited to HL7 datasets transfer protocols.

9. The system of claim 1, wherein said application server engine is configured to execute program written for a plurality of tasks comprising authentication, dataset generation from query, web page formatting, record and file manipulations, not limited to record and file transfer tasks.

10. The system of claim 1, wherein said web server is configured to perform services comprising authentication, treatment history retrieval, laboratory report retrieval, diagnostic report retrieval, diagnostic image retrieval, prescription uploading, laboratory report uploading, diagnostic report uploading, diagnostic images uploading, key word query, not limited to PHR backup and restore services.

11. The system of claim 1, wherein said PHRS is configured to provide interfaces for client systems/users to access the said PHR, wherein said client systems/users may be a single person operating standalone computer or a computer system of a health care provider.

12. The system of claim 11, wherein said interface is configured to accept requests from client systems/users and to respond to said client systems/users with information.

13. The system of claim 11, wherein said PHRS is configured to authenticate said client systems/users and to deny access of the PHR if access is prohibited.

14. The system of claim 1, wherein said PHRS is configured to encrypt all data stored wherein said encryption is performed basing on personal and hardware keys.

15. The system of claim 14, wherein said personal key is a unique key generated for each individual patient.

16. The system of claim 14, wherein said hardware key is a unique key generated for each individual storage device.

17. The system of claim 1, wherein the said storage device may be an USB drive, removable disk or any electronic storage device configured to provide data storage to connecting computing device.

18. The system of claim 1, wherein said PHRS is configured to have all programs of said engines stored in the said storage device.

19. The system of claim 1, wherein said PHRS is configured to perform said PHRS tasks by activating all said engines.

20. The system of claim 1, wherein the said PHRS is configured to backup all PHR data in a backup system, wherein said backup system is configured to stored individual PHR separately with data encrypted wherein said encryption is performed basing on personal key and hardware key.

21. The system of claim 20, wherein said hardware key is a unique key generated for each individual backup system.

22. The system of claim 20, wherein said backup system is configured to perform a plurality of PHRS tasks concurrently with each PHRS task run separately in isolated work space.

23. The system of claim 20, wherein said backup system is configured to receive delayed PHR data from the health care providers and to update the said PHRS when the communication is available.

24. The system of claim 20, wherein said backup system is configured to re-generate the said PHRS in case the PHRS is damaged or lost.
